(19) United States
(12) Patent Application Publication
(10) Pub. No.: US 2026/0161949 A1
(43) Pub. Date: Jun. 11, 2026

(54) LANGUAGE MODELLING WITH FACTORIZATION MEMORY

(71) Applicant: Rakuten Group, Inc., Tokyo (JP)

(72) Inventors: Lee XIONG, Seattle, WA (US); Ting CAI, Tokyo (JP)

(21) Appl. No.: 19/260,365

(22) Filed: Jul. 4, 2025

Related U.S. Application Data
(60) Provisional application No. 63/730,898, filed on Dec. 11, 2024.

(51) Int. Cl. G06N 3/0895

(52) U.S. Cl. CPC G06N 3/0895

(57) ABSTRACT

Language modelling with factorization memory is implemented by calculating a topic affinity weight value for each topic vector among a plurality of topic vectors based on an input token embedding, updating each topic vector among at least some of the plurality of topic vectors based on a corresponding topic affinity weight value, and merging the updated plurality of topic vectors to produce an output token embedding.

### CROSS-REFERENCE TO RELATED APPLICATIONS

This application claims priority to U.S. Provisional Patent Application Ser. No. 63/730,898, filed on Dec. 11, 2024, the entire contents of which are incorporated herein by reference.

### FIELD

The present disclosure relates to language modelling with factorization memory.

### BACKGROUND

Transformer architecture in Large Language Models (LLMs) uses a context window to consider the previous L tokens when producing the next 1 token. To produce a sentence of L tokens, you need O(L²) computations.

### SUMMARY

Language modelling with factorization memory is implemented by calculating a topic affinity weight value for each topic vector among a plurality of topic vectors based on an input token embedding, updating each topic vector among at least some of the plurality of topic vectors based on a corresponding topic affinity weight value, and merging the updated plurality of topic vectors to produce an output token embedding.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic diagram of a portion of a language model, according to at least some embodiments of the subject disclosure.

FIG. 2 is an operational flow for utilizing a recurrent memory state, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

It is computationally prohibitive to scale L to a very large number. For example, 1 GB of email contains hundreds of millions of tokens, far exceeding any commercial API's limit (usually 32 k to 100 k). Transformers do not learn during inference. If we want to adjust its behavior, we need to carry a prompt shorter than L for every conversation turn. Error rate grows with complexity. Prompt engineering and RAG becomes increasingly error-prone as the task complexity increases.

A language model according to at least some embodiments of the subject disclosure utilizes a recurrent memory state including encoded states from previous input from which to base the output. In at least some embodiments, the recurrent memory state is a fixed memory size.

In at least some embodiments, language models generating output based on a recurrent memory state representing previous input requires less memory than language models generating output based on transformer architecture that directly considers previous input within a context window.

In at least some embodiments, the hyperspace of token embeddings is partitioned into M fixed topics. In at least some embodiments, each topic centroid

$${W}_{topic}^{M}$$

serves as all anchor for its partition, with h^{m} representing the memory vector for the m-th topic. In at least some embodiments, each memory vector uses hardware storage of the size of the memory vector.

In at least some embodiments, given an input embedding xₜ, a topic affinity αₜ is calculated across all topic centroids. In at least some embodiments, a final output embedding yₜ is formed as a weighted average of the memory vectors, using or as the weights.

$${α}_{t} = soft max ( {W}_{topic}^{1} \cdot {x}_{t} , {W}_{topic}^{2} \cdot {x}_{t} , … {W}_{topic}^{M} \cdot {x}_{t} ) \qquad EQ . 1$$

$${y}_{t} = {\sum }_{m = 1}^{M} {α}_{t}^{m} \cdot {h}_{t}^{m} \qquad EQ . 2$$

In at least some embodiments, the memory update is also gated by the topic affinities. In at least some embodiments, only memory vectors corresponding to topics closely aligned with the input receive significant updates, while other topic-specific memories remain unaffected:

$${h}_{t}^{m} = {h}_{t - 1}^{m} + {α}_{t}^{m} \cdot η \cdot τ ( {x}_{t} \cdot ( 1 - 𝒫 ( {x}_{t} \vert {h}_{t - 1}^{m} ) ) - {\sum }_{n ∈ ℕ} n \cdot 𝒫 ( n \vert {h}_{t - 1}^{m} ) ) \qquad EQ . 3$$

where η is the learning rate and τ is a scaling temperature parameter.

In at least some embodiments, the negative term in the original memory update rule can be simplified by leveraging the assumption that, in a well-trained embedding space, token embeddings are evenly distributed across their topic partitions. In at least some embodiments, input embeddings are RMS or layer-normalized for each transformer.

In at least some embodiments, a scaling factor for the update is defined as:

$$S ( {h}_{t} , {h}_{x} ) = η \cdot τ \cdot ( 1 - 𝒫 ( {x}_{t} \vert {h}_{t} ) ) \qquad EQ . 4$$

In at least some embodiments, associative parallel scan computation is enabled by simplifying the [symbol] (xₜ|hₜ) to not depend on hₜ, leading to:

$$S ( {h}_{t} , {x}_{t} ) \approx σ ( {W}_{lr} \cdot {x}_{t} ) \cdot ( 1 - {α}_{t}^{m} ) \qquad EQ . 5$$

$$or$$

$$S ( {h}_{t} , {x}_{t} ) \approx η ( τ \cdot r ) = σ ( {W}_{lr} \cdot {x}_{t} ) \qquad EQ . 6$$

and the model becomes:

$${h}_{t}^{m} = ( 1 - {α}_{t}^{m} σ ( {W}_{lr} \cdot {x}_{t} ) ) \cdot {h}_{t - 1}^{m} + {α}_{t}^{m} σ ( {W}_{lr} \cdot {x}_{t} ) \cdot {x}_{t} \qquad EQ . 7$$

With the foregoing memory update equation, it can take multiple steps for

$${h}_{t}^{m} ,$$

which can be initialized as a zero tensor at the beginning of the sequence, to accumulate a stable norm. This gradual norm buildup can delay convergence. In at least some embodiments, a normalization layer, specifically RMS normalization, is incorporated prior to the memory layer's output. In at least some embodiments, RMS normalization aids in stabilizing the output scale across updates. In at least some embodiments, the layer's expressiveness is extended by incorporating input and output projections, which allow dynamic control over memory dimensions and multi-head numbers. In at least some embodiments, an output gating mechanism is also introduced, which empirically enhances model performance with a minimal computational footprint. In at least some embodiments, the architecture here does not require Convolutional 1-Dimensional (Conv1D) processing to maintain robust sequential reasoning, potentially due to its inherent structure and topic-adaptive memory design.

In at least some embodiments, the foregoing is put altogether as the following set of equations for utilizing a recurrent memory state:

$${α}_{t} = soft max ( {W}_{topic}^{1} \cdot {x}_{t} , {W}_{topic}^{2} \cdot {x}_{t} , … {W}_{topic}^{M} \cdot {x}_{t} ) ∈ {ℝ}^{M} \qquad EQ . 8$$

$${η}_{t} = σ ( {W}_{lr} \cdot {x}_{t} ) ∈ {ℝ}^{1} \qquad EQ . 9$$

$${g}_{t} = σ ( {W}_{o} \cdot {x}_{t} ) ∈ {ℝ}^{1} \qquad EQ . 10$$

$${U}_{t}^{n} = {α}_{t} \cdot {η}_{t} ∈ {ℝ}^{M} \qquad EQ . 11$$

$${M}_{t}^{n} = {α}_{t} \cdot {g}_{t} ∈ {ℝ}^{M} \qquad EQ . 12$$

$${h}_{t} = ( 1 - {U}_{t}^{n} ) {h}_{t - 1}^{m} + {U}_{t}^{n} ( {W}_{in} \cdot {x}_{t} ) ∈ {ℝ}^{M \times D} \qquad EQ . 13$$

$${y}_{t} = {W}_{out} \cdot {\sum }_{m = 1}^{M} {M}_{t}^{m} \cdot norm ( {h}_{t}^{m} ) ∈ {ℝ}^{D} \qquad EQ . 14$$

where ηₜ represents topic update rates, Wₗᵣ represents topic update rate weight values, σ(·) represents sigmoid activation, gₜ represents topic merge rates, Wₒ represents topic merge rate weight values,

$${U}_{t}^{n}$$

represents topic update weights,

$${M}_{t}^{n}$$

represents topic merge weights, Wᵢₙ represents an input projection weight matrix, Wₒᵤₜ represents an output projection weight matrix, [symbol] represents a feature space of M dimensions, and D is the length of each topic vector.

In at least some embodiments, the foregoing set of equations for utilizing a recurrent memory state becomes enables scaling to a large number of topic partitions M. In at least some embodiments, αₜ functions as a routing probability, directing updates to only the most relevant partitions.

In at least some embodiments, the update router weight Uⁿ can be viewed as the centroid of memory h^{m}'s designated space. In at least some embodiments, this unblocks parallel training optimizations.

In at least some embodiments, the gating network will also skew (Wᵢₙ·xₜ) away from memory block h^{m} where h^{m} is far from (Wᵢₙ·xₜ) and has a small topic affinity score, thus blocking overriding memories that are storing a different topic, similar to a context switch. In at least some embodiments, topic affinity at is a probability distribution summing up to 1.0, and therefore update weight Uⁿ(Wᵢₙ·xₜ) sums to the learning rate η.

In at least some embodiments, the network is “sparsely activated” so that the computation where Uⁿ(Wᵢₙ·xₜ) is close to 0 can be dropped without significantly affecting the result. In at least some embodiments, this property enables the memory to scales to billions of topics M.

In at least some embodiments, by making a straightforward adaptation, the foregoing set of equations for utilizing a recurrent memory state, which are dense, can be transformed into a sparse variant, significantly enhancing computational efficiency without significantly sacrificing model expressiveness:

$${Pr}_{t} = KeepTopK ( {α}_{t} , K ) ∈ {ℝ}^{K} , K \leq M \qquad EQ . 15$$

$${G}_{t}^{i} = \frac{{Pr}_{t}^{i}}{{\sum }_{j = 1}^{K} {Pr}_{t}^{j}} \qquad EQ . 16$$

$${U}_{t}^{n} = {G}_{t}^{n} \cdot {η}_{t} ∈ {ℝ}^{M} \qquad EQ . 17$$

$${M}_{t}^{n} = {G}_{t}^{n} \cdot {g}_{t} ∈ {ℝ}^{M} \qquad EQ . 18$$

where KeepTopL(·) represents a top-K function, K represents the quantity of topics to be updated, and Gₜ represents spares update affinity weight values.

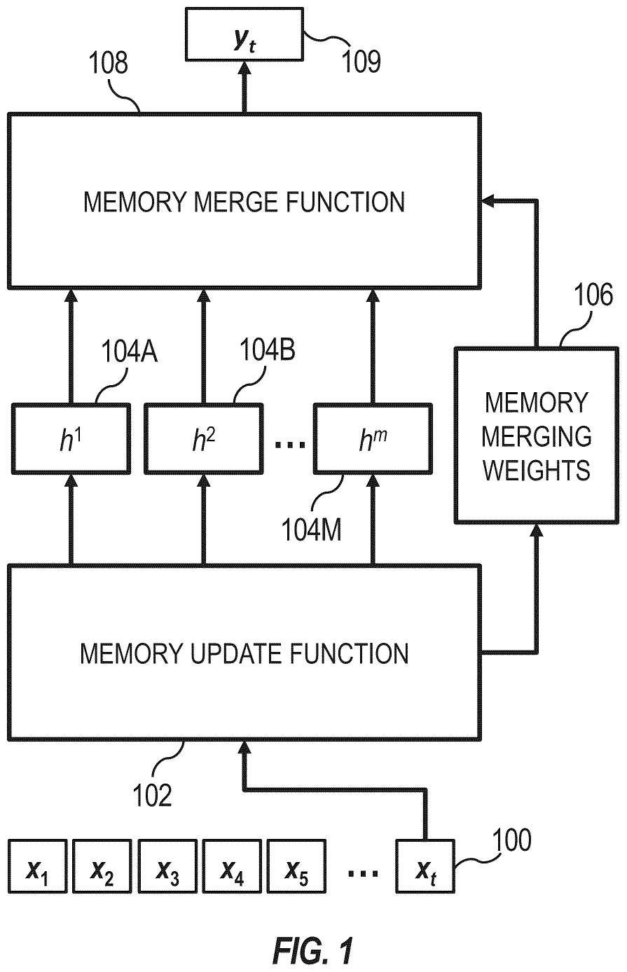

FIG. 1 is a schematic diagram of a portion of a language model, according to at least some embodiments of the subject disclosure. The portion of the language model includes input token embedding 100, memory update function 102, topic vectors 104A, 104B, and 104M, memory merging weights 106, memory merge function 108, and output token embedding 109. In at least some embodiments, the portion of the language model is configured to selectively update parts of a recurrent memory state on which output is based.

Input token embedding 100 is an instance of input the portion of the language model. In at least some embodiments, input token embedding 100 is configured to represent a token of a natural language prompt as a vector in feature space. Although the language model is primarily designed for natural language, the natural language prompt and a natural language response are not strictly limited to natural language. The natural language prompt and the natural language response may include non-linguistic text such as code, mathematical algorithms, programming or markup language, or any other non-linguistic elements that commonly accompany natural language.

Memory update function 102 is an element of the portion of the language model. In at least some embodiments, memory update function 102 is configured to update topic vectors, such as topic vectors 104A, 104B, and 104M, based on topic update weight values. In at least some embodiments, memory update function 102 is further configured to store updated topic vectors in a physical memory.

Topic vectors, such as topic vectors 104A, 104B, and 104M, are elements of the portion of the language model. In at least some embodiments, topic vectors form a recurrent memory state. In at least some embodiments, each of topic vectors 104A, 104B, and 104M are updated by memory update function 102 based on topic update weight values. In at least some embodiments, only some topic vectors are updated in response to each input token embedding. In at least some embodiments, topic vectors are merged by memory merge function 108 to produce output token embedding 109. In at least some embodiments, as the language model is trained, the processor partitions a hyperspace of token embeddings into a plurality of topic partitions. In at least some embodiments, as the language model is trained, the processor encodes a centroid of each topic partition as a topic vector, upon which topic affinity weight values are based.

Memory merging weights 106 are elements of the portion of the language model. In at least some embodiments, memory merging weights 106 are configured to control merging of topic vectors, such as topic vectors 104A, 104B, and 104M, based on affinity of the input token embedding for each topic. In at least some embodiments, memory merging weights 106 are configured to skew the impact on the output token embedding 109 toward topics for which the token embedding has a higher affinity. In at least some embodiments, memory merging weights 106 are computed using topic merge rates and topic affinity scores.

Memory merge function 108 is an element of the portion of the language model. In at least some embodiments, memory merge function 108 is configured to merge updated topic vectors, such as topic vectors 104A, 104B, and 104M, to produce output token embedding 109. In at least some embodiments, memory merge function 108 is configured to compute an output projection of merged topic vectors. In at least some embodiments, memory merge function 108 is further configured to read updated topic vectors from a physical memory.

Output token embedding 109 is an instance of the portion of the language model. In at least some embodiments, output token embedding 109 is produced by merging updated topic vectors, such as topic vectors 104A, 104B, and 104M, using memory merge function 108. In at least some embodiments, output token embedding 109 is an output projection of merged topic vectors.

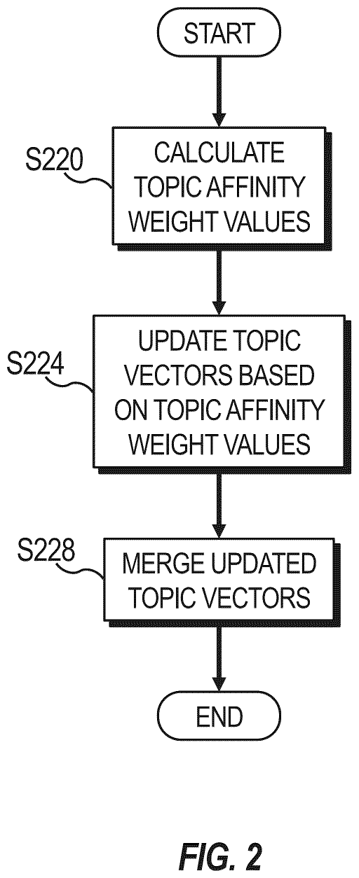

FIG. 2 is an operational flow for utilizing a recurrent memory state, according to at least some embodiments of the subject disclosure. In at least some embodiments, the operational flow provides a method of utilizing a recurrent memory state. In at least some embodiments, the method is performed by a controller of an apparatus.

At S220, controller or a section thereof calculates topic affinity weight values. In at least some embodiments, the processor receives an input token embedding. In at least some embodiments, the processor normalizes the input token embedding before calculating the topic affinity scores. In at least some embodiments, the normalizing is Root-Mean-Square (RMS) normalization. In at least some embodiments, the processor applies a Softmax to calculate the topic affinity scores. In at least some embodiments, the processor calculates topic affinity scores αₜ according to EQ. 8. In at least some embodiments, the topic affinity scores total 1. In at least some embodiments, the processor retrieves the topic affinity weight matrix from among trained parameter values of the language model. In at least some embodiments, the processor retrieves the topic affinity temperature value from among configurable parameters or hyper-parameters. In at least some embodiments, the processor calculates topic affinity scores based on the input token embedding, the topic affinity weight matrix, and the topic affinity temperature value. In at least some embodiments, the processor calculates a topic affinity score for each topic vector among a plurality of topic vectors based on an input token embedding and the topic affinity weight matrix.

In at least some embodiments, the processor performs a sparse update. In at least some embodiments, the processor calculates topic affinity scores such that only topics having the highest affinity scores are updated. In at least some embodiments, after at is calculated according to EQ. 8, the processor selects the top-K relevant memory states according to EQ. 15. In at least some embodiments, as a result of applying EQ. 15, only the highest K affinity scores are preserved, and the others are set to a value of zero. In at least some embodiments, the processor then re-normalizes the affinity scores. In at least some embodiments, the processor proceeds to the topic vector update at S224 and updated topic vector merge at S228 utilizing Gₜ instead of αₜ to perform a sparse update and merge.

At S224, controller or a section thereof updates topic vectors based on topic affinity weight values. In at least some embodiments, the processor computes updated topic vectors based on the input token embedding, the topic update weights, and preceding topic vectors, such as in EQ. 13. In at least some embodiments, the processor computes updated topic vectors only for some topics. In at least some embodiments, the processor updates each topic vector among the at least some of the plurality of topic vectors of which the corresponding topic affinity weight value is among a predetermined quantity of greatest topic affinity weight values. In at least some embodiments, the processor computes updated topic vectors according to topic affinity weight values Gₜ instead of αₜ to perform a sparse update, such as by using EQ. 16. In at least some embodiments, the processor updates each topic vector among the at least some of the plurality of topic vectors of which the corresponding topic affinity weight value is greater than a threshold affinity weight value. In at least some embodiments, the processor retrieves preceding topic vectors from a physical memory. In at least some embodiments, the processor stores the updated topic vectors in the physical memory. In at least some embodiments, the processor updates each topic vector among at least some of the plurality of topic vectors based on a corresponding topic affinity weight value. In at least some embodiments, each topic vector among the plurality of topic vectors has a fixed length.

At S228, controller or a section thereof merges updated topic vectors. In at least some embodiments, the processor computes an output projection of merged topic vectors based on topic merge weights, the updated topic vectors, and output projection weight values, such as in EQ. 14. In at least some embodiments, the processor retrieves the updated topic vectors from the physical memory. In at least some embodiments, the processor merges the updated plurality of topic vectors to produce an output token embedding. In at least some embodiments, the processor merges each topic vector among the at least some of the plurality of topic vectors of which the corresponding topic affinity weight value is among a predetermined quantity of greatest topic affinity weight values. In at least some embodiments, the processor merges updated topic vectors according to topic affinity scores Gₜ instead of αₜ to perform a sparse merge, such as by using EQ. 16.

At least some embodiments are described with reference to flowcharts and block diagrams whose blocks represent (1) steps of processes in which operations are performed or (2) sections of hardware responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer-readable medium includes a tangible device that is able to retain and store instructions for use by an instruction execution device. In some embodiments, the computer-readable medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, language modelling with factorization memory is implemented by calculating a topic affinity weight value for each topic vector among a plurality of topic vectors based on an input token embedding, updating each topic vector among at least some of the plurality of topic vectors based on a corresponding topic affinity weight value, and merging the updated plurality of topic vectors to produce an output token embedding.

In at least some embodiments, language modelling with factorization memory is further implemented by normalizing the input token embedding before calculating the topic affinity weight values. In at least some embodiments, the normalizing is Root-Mean-Square (RMS) normalization. In at least some embodiments, the calculating the topic affinity weight values includes applying a Softmax. In at least some embodiments, the topic affinity weight values total 1. In at least some embodiments, the updating includes updating each topic vector among the at least some of the plurality of topic vectors of which the corresponding topic affinity weight value is greater than a threshold affinity weight value. In at least some embodiments, the updating includes updating each topic vector among the at least some of the plurality of topic vectors of which the corresponding topic affinity weight value is among a predetermined number of greatest topic affinity weight values. In at least some embodiments, language modelling with factorization memory is further implemented by partitioning a hyperspace of token embeddings into a plurality of topic partitions. In at least some embodiments, language modelling with factorization memory is further implemented by encoding a centroid of each topic partition as a topic vector. In at least some embodiments, each topic vector among the plurality of topic vectors has a fixed length. In at least some embodiments, language modelling with factorization memory is further implemented by encoding a natural language input into the input token embedding. In at least some embodiments, language modelling with factorization memory is further implemented by decoding the output token embedding into a natural language output.

In at least some embodiments, language modelling with factorization memory is implemented by calculating a topic affinity weight value for each topic vector among a plurality of topic vectors based on an input token embedding, updating each topic vector among at least some of the plurality of topic vectors based on a corresponding topic affinity weight value, and merging the updated plurality of topic vectors to produce an output token embedding.

In at least some embodiments, language modelling with factorization memory further includes normalizing the input token embedding before calculating the topic affinity weight values. In at least some embodiments, the normalizing is Root-Mean-Square (RMS) normalization. In at least some embodiments, the calculating the topic affinity weight values includes applying a Softmax. In at least some embodiments, the topic affinity weight values total 1. In at least some embodiments, the updating includes updating each topic vector among the at least some of the plurality of topic vectors of which the corresponding topic affinity weight value is greater than a threshold affinity weight value. In at least some embodiments, the updating includes updating each topic vector among the at least some of the plurality of topic vectors of which the corresponding topic affinity weight value is among a predetermined number of greatest topic affinity weight values. In at least some embodiments, language modelling with factorization memory further includes partitioning a hyperspace of token embeddings into a plurality of topic partitions. In at least some embodiments, language modelling with factorization memory further includes encoding a centroid of each topic partition as a topic vector. In at least some embodiments, each topic vector among the plurality of topic vectors has a fixed length. In at least some embodiments, language modelling with factorization memory further includes encoding a natural language input into the input token embedding. In at least some embodiments, language modelling with factorization memory further includes decoding the output token embedding into a natural language output.

In at least some embodiments, language modelling with factorization memory is implemented by a controller comprising circuitry configured to perform operations comprising, calculating a topic affinity weight value for each topic vector among a plurality of topic vectors based on an input token embedding, updating each topic vector among at least some of the plurality of topic vectors based on a corresponding topic affinity weight value, and merging the updated plurality of topic vectors to produce an output token embedding.

In at least some embodiments, language modelling with factorization memory further includes normalizing the input token embedding before calculating the topic affinity weight values. In at least some embodiments, the normalizing is Root-Mean-Square (RMS) normalization. In at least some embodiments, the calculating the topic affinity weight values includes applying a Softmax. In at least some embodiments, the topic affinity weight values total 1. In at least some embodiments, the updating includes updating each topic vector among the at least some of the plurality of topic vectors of which the corresponding topic affinity weight value is greater than a threshold affinity weight value. In at least some embodiments, the updating includes updating each topic vector among the at least some of the plurality of topic vectors of which the corresponding topic affinity weight value is among a predetermined number of greatest topic affinity weight values. In at least some embodiments, language modelling with factorization memory further includes partitioning a hyperspace of token embeddings into a plurality of topic partitions. In at least some embodiments, language modelling with factorization memory further includes encoding a centroid of each topic partition as a topic vector. In at least some embodiments, each topic vector among the plurality of topic vectors has a fixed length. In at least some embodiments, language modelling with factorization memory further includes encoding a natural language input into the input token embedding. In at least some embodiments, language modelling with factorization memory further includes decoding the output token embedding into a natural language output.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium including instructions that, in response to execution by one or more processors, cause performance of operations comprising:
calculating a topic affinity weight value for each topic vector among a plurality of topic vectors based on an input token embedding;
updating each topic vector among at least some of the plurality of topic vectors based on a corresponding topic affinity weight value; and
merging the updated plurality of topic vectors to produce an output token embedding.

2. The computer-readable medium of claim 1, further comprising normalizing the input token embedding before calculating the topic affinity weight values.

3. The computer-readable medium of claim 2, wherein the normalizing is Root-Mean-Square (RMS) normalization.

4. The computer-readable medium of claim 1, wherein the calculating the topic affinity weight values includes applying a Softmax.

5. The computer-readable medium of claim 4, wherein the topic affinity weight values total 1.

6. The computer-readable medium of claim 1, wherein the updating includes updating each topic vector among the at least some of the plurality of topic vectors of which the corresponding topic affinity weight value is greater than a threshold affinity weight value.

7. The computer-readable medium of claim 1, wherein the updating includes updating each topic vector among the at least some of the plurality of topic vectors of which the corresponding topic affinity weight value is among a predetermined number of greatest topic affinity weight values.

8. The computer-readable medium of claim 1, further comprising partitioning a hyperspace of token embeddings into a plurality of topic partitions.

9. The computer-readable medium of claim 8, further comprising encoding a centroid of each topic partition as a topic vector.

10. The computer-readable medium of claim 1, wherein each topic vector among the plurality of topic vectors has a fixed length.

11. The computer-readable medium of claim 1, further comprising encoding a natural language input into the input token embedding.

12. The computer-readable medium of claim 11, further comprising decoding the output token embedding into a natural language output.

13. A method comprising:
calculating a topic affinity weight value for each topic vector among a plurality of topic vectors based on an input token embedding;
updating each topic vector among at least some of the plurality of topic vectors based on a corresponding topic affinity weight value; and
merging the updated plurality of topic vectors to produce an output token embedding.

14. The method of claim 13, further comprising normalizing the input token embedding before calculating the topic affinity weight values.

15. The method of claim 14, wherein the normalizing is Root-Mean-Square (RMS) normalization.

16. The method of claim 13, wherein the calculating the topic affinity weight values includes applying a Softmax.

17. A device comprising:
a controller comprising circuitry configured to perform operations comprising,
calculating a topic affinity weight value for each topic vector among a plurality of topic vectors based on an input token embedding,
updating each topic vector among at least some of the plurality of topic vectors based on a corresponding topic affinity weight value, and
merging the updated plurality of topic vectors to produce an output token embedding.

18. The device of claim 17, further comprising normalizing the input token embedding before calculating the topic affinity weight values.

19. The device of claim 18, wherein the normalizing is Root-Mean-Square (RMS) normalization.

20. The device of claim 17, wherein the calculating the topic affinity weight values includes applying a Softmax.
